(19) United States
(12) Patent Application Publication
(10) Pub. No.: US 2024/0401664 A1
(43) Pub. Date: Dec. 5, 2024

(54) SHOCK ABSORBER AND VALVE

(71) Applicant: KYB Corporation, Tokyo (JP)

(72) Inventors: Kazuyuki MIZUNO, Toyota-shi, Aichi (JP); Yoshifumi KOBAYASHI, Tokyo (JP); Ryota GOMI, Tokyo (JP); Hiroki YOKOYAMA, Tokyo (JP); Yutaro HONJO, Aichi (JP)

(73) Assignee: KYB Corporation, Tokyo (JP)

(21) Appl. No.: 18/698,142

(22) PCT Filed: Sep. 22, 2022
(86) PCT No.: PCT/JP2022/035336

§ 371 Date: Apr. 3, 2024

(30) Foreign Application Priority Data
Oct. 4, 2021 (JP) 2021-163507

(51) Int. Cl. F16F 9/348; F16F 9/512

(52) U.S. Cl. CPC F16F 9/348; F16F 9/512

(57) ABSTRACT

A valve includes: a leaf valve component; an opposing surface opposing to the component, the opposing surface being configured to prohibit passage of working fluid in a liquid path where the component is arranged; and a seating surface configured to come into contact with the component and prohibit passage of the working fluid in the liquid path in a case in which the component is elastically deformed by a predetermined amount, wherein, in an allowing stroke, during which the passage of the working fluid is allowed, the component is elastically deformed in a direction away from the seating surface so as to allow the passage of the working fluid, and the predetermined amount is set such that the component comes into contact with the seating surface when the speed of a piston exceeds an upper limit value of a predetermined normal range in a restricting stroke.

### TECHNICAL FIELD

The present invention relates to a shock absorber and a valve.

### BACKGROUND ART

In general, a shock absorber includes a cylinder, a piston that partitions an interior of the cylinder into a first chamber and a second chamber, a main communicating passage that is provided in the piston and that allows communication between the first chamber and the second chamber, and a main valve that opens and closes the main communicating passage. As described in JP8-223994A, for example, in addition to the above-described communicating passage, the shock absorber may include a sub-communicating passage that allows the communication between the first chamber and the second chamber, a rotary valve that changes a flow-passage cross-sectional area of the sub-communicating passage, and a sub-valve that opens and closes the sub-communicating passage. The rotary valve is rotated by a driving force of an electric motor. With such a configuration, the flow-passage cross-sectional area of the sub-communicating passage is adjusted in accordance with rotation of the rotary valve, as a result, it becomes possible to adjust a damping force characteristic of the shock absorber.

In addition, related to the shock absorber, for example, JP2016-173140A discloses a valve that is configured of a leaf valve component and an opposing surface that opposes to the leaf valve component.

### SUMMARY OF INVENTION

The sub-valve is configured of an annular leaf spring member, and is elastically deformed due to differential pressure to open and close the sub-communicating passage. The sub-valve is configured of an extension-stroke valve that is opened in an extension stroke in which the shock absorber is extended and a compression-stroke valve that is opened in a compression stroke in which the shock absorber is compressed. The leaf valve component of the extension-stroke valve is configured so as to be seated on a seating surface at the initial state and in the compression stroke and so as to be separated from the seating surface in the extension stroke. The leaf valve component of the compression-stroke valve is configured so as to be seated on the seating surface at the initial state and in the extension stroke and so as to be separated from the seating surface in the compression stroke.

The leaf valve component of each valve is elastically deformed in response to the movement of the shock absorber, thereby coming into contact with or moving away from the seating surface. Therefore, each time the shock absorber is moved, the leaf valve component comes into contact with or moves away from the seating surface. When the leaf valve component comes into connect with the seating surface, an abnormal noise is generated.

On the other hand, with the valve disclosed in JP2016-173140A described above, the seating surface is not provided for the leaf valve component, and the generation of the abnormal noise due to the contacting of the both is not caused. However, this valve does not function as a check valve. For example, for the shock absorber in which an extension-stroke liquid path and a compression-stroke liquid path are formed independently of each other, a valve having the check valve function is essential.

An object of the present invention is to provide a valve capable of suppressing generation of abnormal noise and exhibiting a check valve function, and a shock absorber including the valve.

According to an aspect of the present invention, a shock absorber includes a cylinder, a piston slidably arranged in the cylinder and configured to partition an interior of the cylinder into a first chamber and a second chamber, a liquid path configured to allow communication between the first chamber and the second chamber provided in the cylinder, and a valve provided for the liquid path. The valve includes a leaf valve component having a fixed end and a free end, an opposing surface opposing to the free end of the leaf valve component and configured to prohibit, at least in a state in which the leaf valve component is not elastically deformed, together with the leaf valve component, passage of working fluid in the liquid path where the leaf valve component is arranged, and a seating surface configured to prohibit, in a case in which the leaf valve component is elastically deformed by a predetermined amount in a restricting stroke, during which passage of the working fluid is restricted, together with the leaf valve component by coming into contact with the leaf valve component, passage of the working fluid in the liquid path where the leaf valve component is arranged. In an allowing stroke, during which passage of the working fluid is allowed, the leaf valve component is elastically deformed in a direction away from the seating surface so as to allow passage of the working fluid via a clearance between the free end and the opposing surface, and the predetermined amount is set such that the leaf valve component comes into contact with the seating surface when a speed of the piston exceeds an upper limit value of a predetermined normal range in the restricting stroke.

According to another aspect of the present invention, a valve provided in a shock absorber and described below is provided. That is, the valve is provided for a liquid path configured to allow communication between chambers provided in the shock absorber. the valve includes a leaf valve component having a fixed end and a free end, an opposing surface opposing to the free end of the leaf valve component and configured to prohibit, at least in a state in which the leaf valve component is not elastically deformed, together with the leaf valve component, passage of working fluid in the liquid path where the leaf valve component is arranged, and a seating surface configured to prohibit, in a case in which the leaf valve component is elastically deformed by a predetermined amount in a restricting stroke, during which passage of the working fluid is restricted, together with the leaf valve component by coming into contact with the leaf valve component, passage of the working fluid in the liquid path where the leaf valve component is arranged.

### BRIEF DESCRIPTION OF DRAWINGS

FIG. 1 is a conceptual diagram of a shock absorber of the present embodiment.

FIG. 2 is a conceptual cross-sectional diagram showing a detailed configuration (except a cylinder) of the shock absorber of the present embodiment.

FIG. 3 is a conceptual diagram of an inner pipe of the present embodiment.

FIG. 4 is a conceptual cross-sectional diagram showing a cross section orthogonal to the axial direction of a hollow rod, a rotary valve, and the inner pipe of the present embodiment.

FIG. 5 is a conceptual cross-sectional diagram showing a cross section orthogonal to the axial direction of the hollow rod and the rotary valve in a conventional configuration without the inner pipe.

FIG. 6 is a partial enlarged view of a lower rod hole and valve hole in FIG. 5.

FIG. 7 is a conceptual diagram of an extension-stroke valve of the present embodiment.

FIG. 8 is a conceptual diagram of the extension-stroke valve of the present embodiment.

FIG. 9 is a conceptual diagram of the extension-stroke valve of the present embodiment.

FIG. 10 is a conceptual diagram of the extension-stroke valve of the present embodiment.

FIG. 11 is a conceptual diagram of the extension-stroke valve of the present embodiment.

FIG. 12 is a diagram showing a relationship between a travel time ratio and a piston speed in the present embodiment.

FIG. 13 is a diagram showing a relationship between the piston speed and both of a damping force and a valve opening/closing speed.

FIG. 14 is a conceptual diagram of a compression-stroke valve of the present embodiment.

FIG. 15 is a conceptual diagram showing a modified mode of an extension-stroke valve of the present embodiment.

### DESCRIPTION OF EMBODIMENT

An embodiment of the present invention will be described below with reference to the attached drawings.

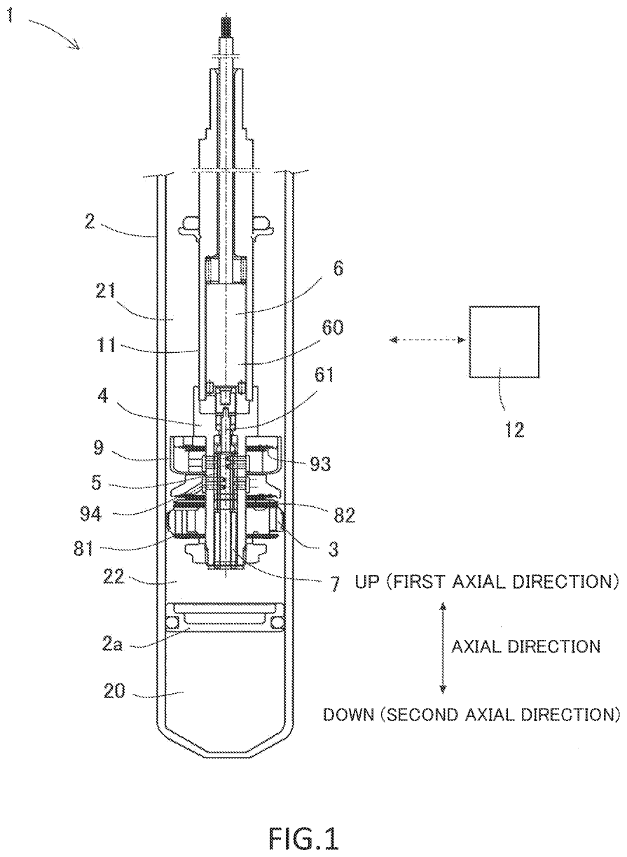

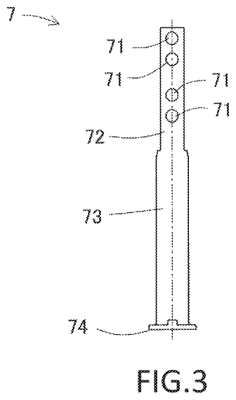

A shock absorber 1 according to the present embodiment is provided for each wheel of a vehicle in order to dampen unsprung vibration. As shown in FIGS. 1, 2, and 3, the shock absorber 1 includes a cylinder 2, a piston 3, a hollow rod 4, a rotary valve 5, an electric motor 6, an inner pipe 7 serving as a tubular member, a main valve mechanism 8, and a sub-valve mechanism 9.

The cylinder 2 is a bottomed cylindrical member and is filled with a working fluid. In the following, in the description, the direction parallel to the center axis of the cylinder 2 is defined as the axial direction, the first side in the axial direction is defined as the upward direction, and the second side in the axial direction is defined as the downward direction. An upper end portion of the cylinder 2 is closed by an end cap (not shown), and a gas chamber 20 is formed in a lower end portion of the cylinder 2. The gas chamber 20 is partitioned by a free piston 2a and the lower end portion including a bottom surface of the cylinder 2. Because the volume of a rod portion 11 present within the cylinder 2 is changed along with the extension and compression of the shock absorber 1, the gas chamber 20 is provided to absorb the volume change.

The rod portion 11 extends through the end cap at an upper end of the cylinder 2 to the outside of the cylinder 2. Although not illustrated, an upper end of the rod portion 11 is linked to a vehicle body, a lower end of the cylinder 2 is linked to an unsprung member of the vehicle. A spring (not shown) is arranged on an outer circumferential side of the rod portion 11.

The piston 3 is arranged within the cylinder 2 so as to be slidable. The piston 3 is a columnar member that partitions an interior of the cylinder 2 into an upper chamber 21 serving as the first chamber and a lower chamber 22 serving as the second chamber. The piston 3 is arranged such that the center axis of the piston 3 is aligned with the center axis of the cylinder 2 and so as to be slidable in the axial direction. The piston 3 is connected to the rod portion 11 via the hollow rod 4. In other words, the piston 3, the hollow rod 4, and the rod portion 11 are moved integrally.

The upper chamber 21 and the lower chamber 22 are each formed by being partitioned by the cylinder 2 and the piston 3. In a state in which the shock absorber 1 is installed in the vehicle, the upper chamber 21 is positioned above the piston 3 and the lower chamber 22 is positioned below the piston 3. An outer circumferential surface (a sliding surface) of the piston 3 is made of a resin.

In the piston 3, a first main communicating passage 31 and a second main communicating passage 32 are each formed independently of each other such that the upper chamber 21 and the lower chamber 22 are communicated. The first main communicating passage 31 (corresponding to “a communicating passage”) is a liquid path whose upper end and lower end open to the upper chamber 21 and the lower chamber 22, respectively, and a lower end opening is closed by a first main valve 81. During the extension stroke in which the shock absorber 1 is extended, the pressure in the upper chamber 21 becomes higher than the pressure in the lower chamber 22, and the first main valve 81 (corresponding to “a valve mechanism”) is opened, and thereby, the upper chamber 21 and the lower chamber 22 are communicated via the first main communicating passage 31. The first main valve 81 is configured of an annular leaf spring member that is fixed to the hollow rod 4. As an outer circumference portion of the first main valve 81 is moved downward by the elastic deformation, the lower end of the first main communicating passage 31 opens to the lower chamber 22.

The second main communicating passage 32 (corresponding to “communicating passage”) is a liquid path whose upper end and lower end open to the upper chamber 21 and the lower chamber 22, respectively, and an upper end opening is closed by a second main valve 82 (corresponding to “a valve mechanism”). In a compression stroke in which the shock absorber 1 is compressed, the pressure in the lower chamber 22 becomes higher than the pressure in the upper chamber 21, and the second main valve 82 is opened, and thereby, the upper chamber 21 and the lower chamber 22 are communicated via the second main communicating passage 32. The second main valve 82 is configured of an annular leaf spring member that is fixed to the hollow rod 4. As an outer circumference portion of the second main valve 82 is moved upward by elastic deformation, the upper end of the second main communicating passage 32 opens to the upper chamber 21. As described above, the main valve mechanism 8 is configured of the first main valve 81, the second main valve 82, the first main communicating passage 31, and the second main communicating passage 32.

The hollow rod 4 is a cylindrical member that is arranged so as to penetrate through the piston 3. The hollow rod 4 has rod holes 41 that open to the upper chamber 21 and an inner liquid path 42 that allows communication between the rod holes 41 and the lower chamber 22. An upper end portion of the hollow rod 4 is closed by the rod portion 11 that is fixed to the upper end portion. A lower end portion of the hollow rod 4 opens to the lower chamber 22. A plurality of the rod holes 41 are formed at a portion of a side surface of the hollow rod 4 that is located in the upper chamber 21. In the present embodiment, two rows of rod holes 41, each of which is consisting of four rod holes 41 spaced apart in the axial direction, are formed in the hollow rod 4 so as to be spaced apart in the circumferential direction (eight holes in total). The inner liquid path 42 is formed within the hollow rod 4. In other words, the inner liquid path 42 is a liquid path that is located within the hollow rod 4 so as to extend in the axial direction. The inner liquid path 42 can be described as a portion through which the working fluid flows inside the hollow rod 4.

The rotary valve 5 is arranged inside the hollow rod 4 so as to be rotatable. The rotary valve 5 is a hollow member (a cylindrical member) having valve holes 51, which, together with the rod holes 41, allow communication between the upper chamber 21 and the inner liquid path 42. There is almost no clearance between an outer circumferential surface of the rotary valve 5 and the inner circumferential surface of the hollow rod 4, and the working fluid is not allowed to flow through the clearance. It can also be said that the clearance exists to the extent that it does not allow the flow of the working fluid. An upper end portion of the rotary valve 5 is fixed to an output shaft portion 61 of the electric motor 6. The rotary valve 5 is rotated by a driving force from the electric motor 6. A plurality of the valve holes 51 are formed so as to correspond to the rod holes 41. In other words, in the present embodiment, two rows of valve holes 51, each of which is consisting of four valve holes 51 spaced apart in the axial direction, are formed in the rotary valve 5 so as to be spaced apart in the circumferential direction (eight holes in total). A lower end of the rotary valve 5 is positioned above the lower end of the hollow rod 4. “The axial direction” can also be described as follows. That is, the direction in which the rotation axis of the rotary valve 5 extends is defined as the axial direction, the direction extending from the piston 3 towards the upper chamber 21 is defined as the first axial direction (the upward direction), and the direction extending from the piston 3 towards the lower chamber 22 is defined as the second axial direction (the downward direction). The extended line of the rotation axis of the rotary valve 5 is aligned with the extended line of the center axis of the cylinder 2.

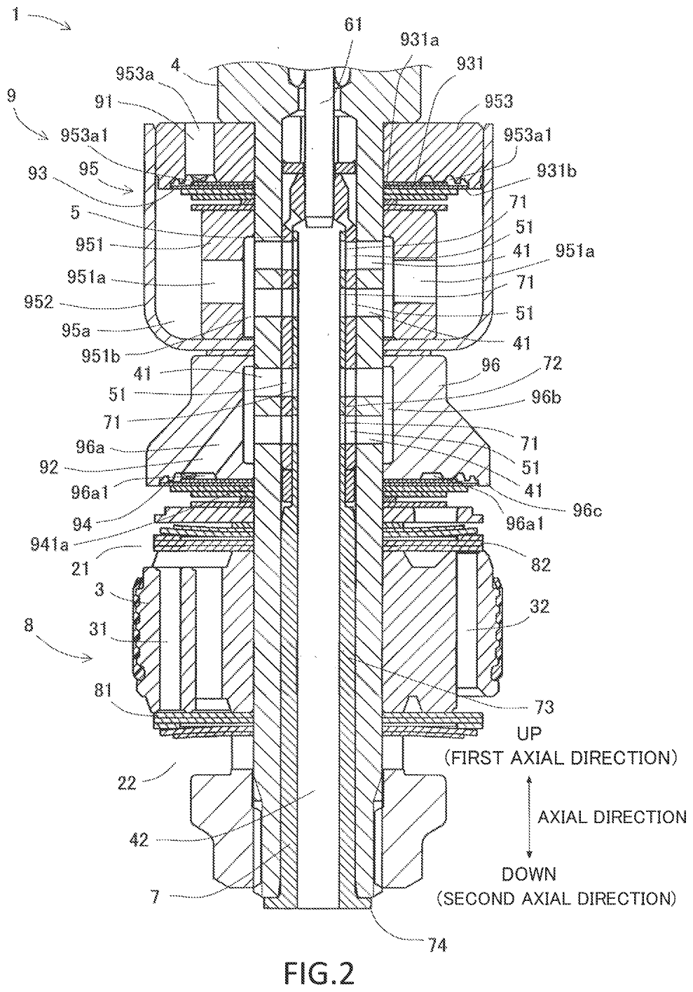

The electric motor 6 is configured so as to adjust the cross-sectional area (also referred to as the flow-passage cross-sectional area or opening area) of liquid paths formed by the rod holes 41 and the valve holes 51 by rotating the rotary valve 5. The flow-passage cross-sectional area of the liquid path connecting the upper chamber 21 and the inner liquid path 42 is changed in accordance with the phase of the valve holes 51. The electric motor 6 is an example of an actuator, and for example, a rotary solenoid may also be employed instead of the electric motor 6. In addition, the flow-passage cross-sectional area can be described as the area of the cross section obtained by cutting the object in a plane perpendicular to the flow direction of the working fluid (the penetrating direction of the hole). In addition, in FIG. 2, for convenience of the drawing, the holes 41, 51, and 71, which are symmetrically arranged in the left-right direction, are respectively assigned with the reference numerals only on one of the left and right sides (i.e., reference numerals are omitted for four of the eight holes).

A main body portion 60 of the electric motor 6 is fixed within the rod portion 11. The electric motor 6 is a stepping motor, for example. The output shaft portion 61 of the electric motor 6 extends downwards (in the second axial direction) from the main body portion 60 and is formed of a plurality of members. The driving force from the electric motor 6 is transmitted to the rotary valve 5 by the output shaft portion 61. The driving of the electric motor 6 is controlled by a controller 12. The controller 12 is an electronic control unit (ECU) including a CPU, a memory, and so forth.

The inner pipe 7 is a cylindrical member that is arranged inside the rotary valve 5 so as not to be moved relative to the hollow rod 4 and so as to cover at least a part of the inner circumferential surface of the rotary valve 5. The inner pipe 7 is fixed to the hollow rod 4. The inner circumferential surface of the inner pipe 7 forms at least a part of the inner liquid path 42. In the present embodiment, because the inner pipe 7 extends from the upper end portion of the rotary valve 5 to the lower end of the hollow rod 4, the entire inner liquid path 42 is formed of the inner circumferential surface of the inner pipe 7.

The inner pipe 7 has communication holes 71 at positions respectively opposing to the rod holes 41. In other words, a plurality of communication holes 71 are formed in a side surface of the inner pipe 7 so as to correspond to the rod holes 41. In the present embodiment, two rows of communication holes 71, each of which is consisting of four communication holes 71 spaced apart in the axial direction, are formed in the inner pipe 7 so as to be spaced apart in the circumferential direction (eight holes in total).

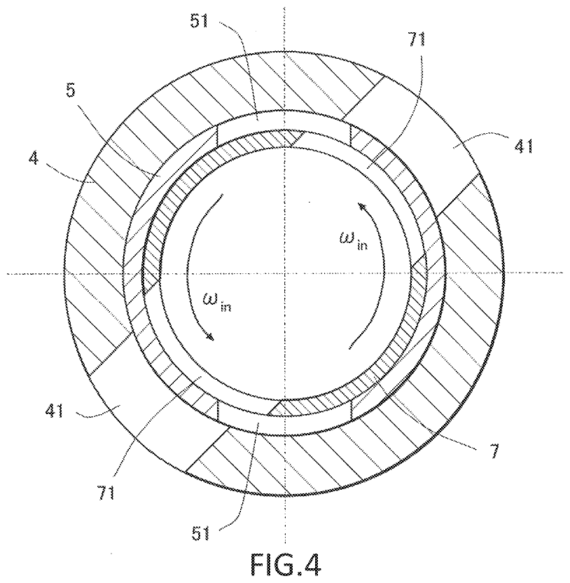

As shown in FIG. 4, in the present embodiment, the opening area of each communication hole 71 (the flow-passage cross-sectional area) is larger than the opening area of each rod hole 41 (the flow-passage cross-sectional area) such that disposition of the rod hole 41 within the communication hole 71 when viewed in the radial direction is facilitated, in other words, such that each rod hole 41 entirely overlaps with each communication hole 71 in the radial direction with ease. The rod holes 41 and the communication holes 71 are formed in the same phase. As described above, the communication between the upper chamber 21 and the inner liquid path 42 is allowed by the rod holes 41, the valve holes 51, and the communication holes 71. The opening area of each of the rod holes 41 and the opening area of each of the valve holes 51 are the same.

More specifically, the inner pipe 7 has a configuration that includes a small-diameter portion 72 that forms an upper side (the first axial direction) portion and a large-diameter portion 73 that forms a lower side (the second axial direction) portion. The small-diameter portion 72 and the large-diameter portion 73 are formed integrally. The outer diameter of the small-diameter portion 72 is smaller than the outer diameter of the large-diameter portion 73. The inner diameters of both portions are equivalent. The difference between the outer diameter of the small-diameter portion 72 and the outer diameter of the large-diameter portion 73 corresponds to the thickness of the rotary valve 5 (the width in the radial direction).

The rotary valve 5 is arranged between an outer circumferential surface of the small-diameter portion 72 and an inner circumferential surface of the hollow rod 4. In other words, a lower end of the small-diameter portion 72 is positioned below the lower end of the rotary valve 5. An upper end of the small-diameter portion 72 is positioned at the position corresponding to the upper end portion of the rotary valve 5. There is almost no clearance between an outer circumferential surface of the small-diameter portion 72 and the inner circumferential surface of the rotary valve 5, and the working fluid is not allowed to flow through the clearance. It can also be said that the clearance exists to the extent that it does not allow the flow of the working fluid. All of the communication holes 71 are formed in the small-diameter portion 72.

The large-diameter portion 73 is arranged so as to oppose an inner circumferential surface of the hollow rod 4. The large-diameter portion 73 extends from a position below the lower end of the rotary valve 5 to the lower end of the hollow rod 4. There is almost no clearance between an outer circumferential surface of the large-diameter portion 73 and the inner circumferential surface of the hollow rod 4, and the working fluid is not allowed to flow through the clearance. It can also be said that the clearance exists to the extent that it does not allow the flow of the working fluid. A lower end of the large-diameter portion 73 is formed with a flange portion 74 that comes into contact with a lower end surface of the hollow rod 4. A lower end portion of the inner pipe 7 and the lower end portion of the hollow rod 4 are fixed by being crimped together, for example. Because the inner pipe 7 is fixed to the lower end portion of the hollow rod 4, for example, it becomes possible to carry out a fixing operation after arranging the respective members inside the hollow rod 4, thereby facilitating the manufacturing and assembly process of the shock absorber 1. It should be noted that the fixation of the inner pipe 7 to the hollow rod 4 is not limited to the crimping, and it is possible to apply well-known methods.

The sub-valve mechanism 9 is a valve mechanism that is provided inside the cylinder 2 separately from the main valve mechanism 8 and has a configuration including the rotary valve 5. The sub-valve mechanism 9 includes an extension-stroke liquid path 91, a compression-stroke liquid path 92, an extension-stroke valve 93, and a compression-stroke valve 94. The extension-stroke liquid path 91 and the compression-stroke liquid path 92 are respectively provided separately from the main communicating passages 31 and 32, and are liquid paths that independently allow communication between the upper chamber 21 and the lower chamber 22. A part of the extension-stroke liquid path 91 is formed by a first liquid path forming portion 95, and a part of the compression-stroke liquid path 92 is formed by a second liquid path forming portion 96.

The first liquid path forming portion 95 includes a tubular member 951 that is fixed to the outer circumferential surface of the hollow rod 4, a bottomed tubular member 952 that is fixed to the outer circumferential surface of the hollow rod 4 so as to surround the tubular member 951, and a lid member 953 that is fixed to the outer circumferential surface of the hollow rod 4 so as to close an upper opening of the bottomed tubular member 952.

The tubular member 951 has a cylindrical shape and is arranged so as to oppose to upper four rod holes 41 of the eight rod holes 41. Two liquid paths 951a extending in the radial direction are formed at positions of a side surface of the tubular member 951 corresponding to the rod holes 41 so as to be spaced apart in the circumferential direction. In addition, an annular liquid path 951b that connects the two liquid paths 951a is formed in an inner circumferential portion of the tubular member 951. All of the four rod holes 41 located in the tubular member 951 open to the liquid path 951b. The liquid path 951b is partitioned by an inner circumferential surface of the tubular member 951, the outer circumferential surface of the hollow rod 4, and the bottomed tubular member 952.

The bottomed tubular member 952 is formed to have a bottomed cylindrical shape having a diameter larger than that of the tubular member 951. A clearance that allows flow of the working fluid is formed between an outer circumferential surface of the bottomed tubular member 952 and an inner circumferential surface of the cylinder 2. The clearance can be described as an annular liquid path. A bottom surface forming a lower end of the bottomed tubular member 952 is in contact with a lower end surface of the tubular member 951. An annular liquid chamber 95a is formed inside the bottomed tubular member 952 by an inner circumferential surface of the bottomed tubular member 952, an outer circumferential surface of the tubular member 951, and the lid member 953.

The lid member 953 is a cylindrical member and one or more through hole(s) 953a (three holes in this case) is/are formed in the lid member 953 so as to allow communication between the upper chamber 21 and the liquid chamber 95a. The three through holes 953a each extends in the axial direction and are arranged so as to be spaced apart in the circumferential direction from each other. A lower end portion of each of the through holes 953a forms a liquid chamber 953a1 that extends in the circumferential direction. In other words, a lower end opening portion of each of the through holes 953a expands so as to extend in the circumferential direction and forms the liquid chamber 953a1 having relatively large flow-passage cross-sectional area. Therefore, as shown in the right side portion of the lid member 953 in FIG. 2, the liquid chamber 953a1 that is a space between the extension-stroke valve 93 and the lid member 953 forms a part of the through hole 953a, which is not shown. As described above, the extension-stroke liquid path 91 is configured of the through holes 953a, the liquid chamber 95a, the liquid paths 951a, the liquid path 951b, the rod holes 41, the valve holes 51, the communication holes 71, and the inner liquid path 42.

The extension-stroke valve 93 is arranged inside the liquid chamber 95a so as to close the lower end opening of the through holes 953a. The extension-stroke valve 93 is arranged between the tubular member 951 and the lid member 953 inside the bottomed tubular member 952, and is fixed to the outer circumferential surface of the hollow rod 4. The extension-stroke valve 93 is configured so as to allow the passage of the working fluid from the upper chamber 21 to the lower chamber 22 via the extension-stroke liquid path 91 in the extension stroke, and to restrict the passage of the working fluid from the lower chamber 22 to the upper chamber 21 via the extension-stroke liquid path 91 in the compression stroke. In the following, in the description, the stroke that allows the passage of the working fluid is also referred to as an allowing stroke, and the stroke that restricts the passage of the working fluid is also referred to as a restricting stroke.

In the extension stroke, lower ends of the through holes 953a open to the liquid chamber 95a as the piston 3 slides upwards, the pressure in the upper chamber 21 becomes higher than the pressure in the lower chamber 22, and the extension-stroke valve 93 is opened by being elastically deformed downward. As a result, the working fluid flows from the upper chamber 21 to the lower chamber 22 via the extension-stroke liquid path 91. A detailed configuration of the extension-stroke valve 93 will be described later.

The second liquid path forming portion 96 is a cylindrical member and is arranged between the first liquid path forming portion 95 and the piston 3. An annular liquid path (a clearance) that allows passage of the working fluid is formed between the second liquid path forming portion 96 and the cylinder 2. The second liquid path forming portion 96 is fixed to the outer circumferential surface of the hollow rod 4 so as to oppose lower four rod holes 41 of the eight rod holes 41. The second liquid path forming portion 96 is formed with liquid paths 96a and 96b that allow communication between the upper chamber 21 and the rod holes 41.

One or more liquid path(s) 96a is/are formed in the second liquid path forming portion 96 (in this case, three paths are formed so as to be spaced apart in the circumferential direction). Each of the liquid paths 96a extends at an angle relative to the axial direction so as to extend radially outward towards the lower side. A lower end and an upper end of the liquid path 96a open to the upper chamber 21 and the liquid path 96b, respectively. The liquid path 96b is an annular liquid path that is formed in an inner circumferential portion of the second liquid path forming portion 96 such that all of the liquid paths 96a communicate thereto. All of four rod holes 41, which are located in the second liquid path forming portion 96, open to the liquid path 96b. A lower end portion of the liquid path 96a forms a liquid chamber 96a1 that extends in the circumferential direction.

As described above, the compression-stroke liquid path 92 is configured of the liquid path 96a, the liquid path 96b, the rod holes 41, the valve holes 51, the communication holes 71, and the inner liquid path 42. The inner liquid path 42 is the liquid path for both of the liquid paths 91 and 92.

The compression-stroke valve 94 is arranged below the second liquid path forming portion 96 so as to close a lower end opening of the liquid path 96a (the liquid chamber 96a1). The compression-stroke valve 94 is configured so as to allow the passage of the working fluid from the lower chamber 22 to the upper chamber 21 via the compression-stroke liquid path 92 in the compression stroke, and to restrict the passage of the working fluid from the upper chamber 21 to the lower chamber 22 via the compression-stroke liquid path 92 in the extension stroke. In the compression stroke, the lower ends of the liquid paths 96a open to the upper chamber 21 as the piston 3 slides downwards, the pressure in the lower chamber 22 becomes higher than the pressure in the upper chamber 21, and the compression-stroke valve 94 is opened by being elastically deformed downward. As a result, the working fluid flows from the lower chamber 22 to the upper chamber 21 via the compression-stroke liquid path 92. A detailed configuration of the compression-stroke valve 94 will be described later.

The respective components (the cylinder 2, the piston 3, the hollow rod 4, the rotary valve 5, the output shaft portion 61, the inner pipe 7, the valves 81, 82, 93, and 94, the liquid path forming portions 95 and 96, and so forth) of the shock absorber 1 described above are arranged such that the straight lines containing their respective central axes coincide with each other. In other words, the respective components are arranged coaxially.

### (Torque Applied to Rotary Valve)

As the rotary valve 5 is rotated and the cross-sectional area of the liquid path formed by the rod holes 41 and the valve holes 51 is reduced, at the time of extension and compression of the shock absorber 1, it becomes difficult for the working fluid to flow through the extension-stroke liquid path 91 or the compression-stroke liquid path 92, resulting in a harder drive feeling. On the other hand, as the cross-sectional area of the liquid path is increased, it becomes easier for the working fluid to flow through the extension-stroke liquid path 91 or the compression-stroke liquid path 92, resulting in a softer drive feeling.

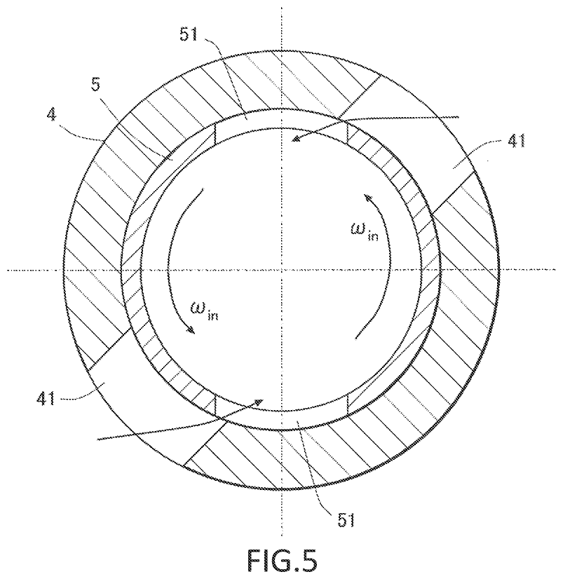

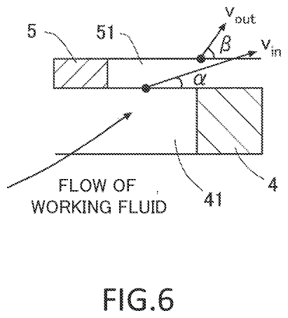

In the conventional configuration without the inner pipe 7 (hereinafter also referred to as “the conventional configuration”), the rotary valve 5 receives torque due to a fluid force generated when the working fluid flows therethrough. In the above, with reference to FIGS. 5 and 6, a description will be given of a case in which, the working fluid flows from the upper chamber 21 into the rotary valve 5 via the rod holes 41 and the valve holes 51 (corresponding to the inner liquid path 42) in the extension stroke, in the conventional configuration. FIG. 6 is a partial enlarged view (a conceptual diagram) of the rod hole 41 and the valve hole 51 in a lower part in FIG. 5. In addition, in the description, the right direction in FIG. 6 is referred to as the positive direction.

When the working fluid flows into the rotary valve 5, the working fluid is decelerated by receiving a force in the leftward direction in FIG. 6. On the other hand, the rotary valve 5 receives a force (reaction force) in the rightward direction in FIG. 6 due to the inflow of the working fluid. In other words, the rotary valve 5 receives a counterclockwise torque. When an inflow velocity of the working fluid from the rod hole 41 to the valve hole 51 is Vin, an inflow angle of the working fluid at this time is a, an inflow velocity of the working fluid from the valve hole 51 to the rotary valve 5 is Vout, an inflow angle of the working fluid at this time is B, the inner diameter of the rotary valve 5 is r, the density of the working fluid is p, and the flow rate the working fluid is Q, the fluid force F and torque T1 received by the rotary valve 5 can be expressed by the following equations.

$$\begin{matrix}F = - ρ Q ( Vout cos β - Vin cos α ) \\ T 1 = 2 rF\end{matrix}$$

Furthermore, the rotary valve 5 receives the counterclockwise torque in accordance with the length L in the axial direction. The working fluid that has entered inside the rotary valve 5 flows in a swirling motion as the working fluid flows through the liquid path (in the rotary valve 5) of the length L. Therefore, the working fluid is decelerated due to the resistance imparted by the inner circumferential surface of the rotary valve 5, and the fluid force acts on the rotary valve 5. When a rotational speed of the counterclockwise flow of the working fluid generated in the vicinity of the valve hole 51 of the rotary valve 5 (an inlet) is win, and a rotational speed of the counterclockwise flow of the working fluid generated in the vicinity of a lower end portion of the rotary valve 5 (an outlet) is ωout, a torque T2 received by the rotary valve 5 due to the swirling motion of the working fluid inside the rotary valve 5 in the conventional configuration can be expressed by the following equation.

$$T 2 = - r ρ Q ( ω out - ω i n )$$

### (Effect Afforded by Inner Pipe)

According to the present embodiment, the inner pipe 7 is arranged inside the rotary valve 5 and forms the inner liquid path 42. Therefore, at least a part of the fluid force (the torque T2) generated inside the rotary valve 5 is received by the inner pipe 7, and so, it is possible to reduce the torque received by the rotary valve 5 correspondingly. As described above, according to the present embodiment, the torque T2 caused by the swirling motion of the working fluid that has entered inside the rotary valve 5 is received by the inner pipe 7. As a result, it is possible to reduce the torque to be received by the rotary valve 5 and to reduce a load on the electric motor 6. In addition, it is possible to reduce the torque T1 generated at the time of inflow and outflow of the working fluid by reducing the thickness of the rotary valve 5. It is believed that the presence of the inner pipe 7 improves a structural durability of the rotary valve 5, and thereby, it also becomes possible to reduce the thickness of the rotary valve 5.

The inner pipe 7 in the present embodiment is arranged so as to cover a portion of the inner circumferential surface of the rotary valve 5 corresponding to the inner liquid path 42 over the entire axial direction. In other words, an upper end of the inner pipe 7 (a first end portion in the axial direction) is positioned above the uppermost valve holes 51, and a lower end of the inner pipe 7 (a second end portion in the axial direction) is positioned below the lower end of the rotary valve 5. With such a configuration, it is possible to make the length L of a portion of the rotary valve 5 that receives the fluid force pseudo-zero or close to zero, and so, it is possible to make the torque generated due to a resistance caused by the wall surface of the rotary valve 5 (a resistance caused by the inner circumferential surface) close to 0 (T2≈0).

In addition, because the inner pipe 7 includes the small-diameter portion 72, it is possible to assemble the inner pipe 7 to the existing configuration including the hollow rod 4 and the rotary valve 5 without any design change, in other words, with ease. The numbers and positions of the respective holes 41, 51, and 71 may be set arbitrarily.

### (Detailed Configuration of Extension-Stroke Valve)

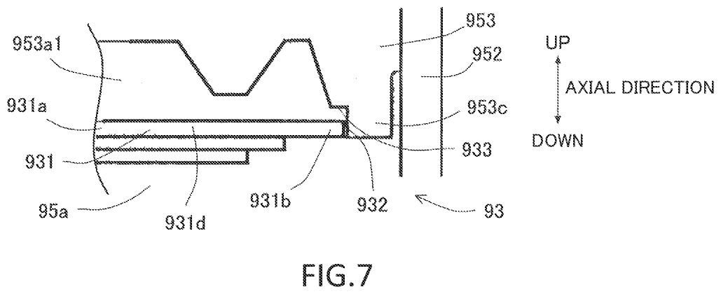

As shown in FIGS. 2 and 7, the extension-stroke valve 93 has a configuration including a leaf valve component 931 (corresponding to “an extension-stroke leaf valve component”), an opposing surface 932 (corresponding to “an extension-stroke opposing surface”), and a seating surface 933 (corresponding to “an extension-stroke seating surface”). The leaf valve component 931 has a fixed end 931a and a free end 931b. An inner circumferential portion of the leaf valve component 931 is the fixed end 931a that is fixed to the hollow rod 4, and an outer circumference portion thereof is the free end 931b. The leaf valve component 931 is configured of one or more annular leaf spring member(s).

The leaf valve component 931 is arranged under the lid member 953 so as to close a lower end opening of the through hole 953a (the liquid chamber 953a1). The leaf valve component 931 is formed by a plurality of annular leaf spring members stacked in the axial direction, and the damping characteristics can be adjusted by the number and the thickness of the leaf spring members. The leaf valve component 931 in the present embodiment is formed of three leaf spring members stacked in the axial direction with the outer diameter being reduced from the top towards the bottom. The leaf valve component 931 undergoes elastic deformation due to the differential pressure above and below it, and thereby, the free end 931b is displaced.

The opposing surface 932 opposes the free end 931b of the leaf valve component 931, and at least in a state in which the leaf valve component 931 is not elastically deformed, the opposing surface 932 prohibits, together with the leaf valve component 931, the passage of the working fluid in the liquid path where the leaf valve component 931 is arranged (in other words, the extension-stroke liquid path 91). A clearance between the leaf valve component 931 and the opposing surface 932 is set so as not to allow the passage of the working fluid. The opposing surface 932 is formed to have an annular shape so as to surround an outer circumferential surface of a leaf spring member 931d of the leaf valve component 931 having the largest outer diameter. An overlapped amount in the radial direction between the leaf spring member 931d and the opposing surface 932 (corresponding to the thickness of the leaf spring member 931d) affects the ease of the state change from the closed state to the opened state of the extension-stroke valve 93. The position of a lower end of the leaf spring member 931d of the leaf valve component 931 coincides with the position of a lower end of the opposing surface 932 in the axial direction.

The opposing surface 932 is formed by a lower end portion of the lid member 953. An annular portion 953c which projects annularly is formed on an outer circumference portion of a lower end of the lid member 953. The opposing surface 932 is an inner circumferential surface of this annular portion 953c. An outer circumferential surface of the leaf valve component 931 opposes the inner circumferential surface of the annular portion 953c (the opposing surface 932) over its entire circumference.

In a case in which the leaf valve component 931 is elastically deformed by a predetermined amount in the restricting stroke, during which the passage of the working fluid is restricted, the seating surface 933 is brought into contact with the leaf valve component 931 and prohibits, together with the leaf valve component 931, the passage of the working fluid in the liquid path where the leaf valve component 931 is arranged (in other words, the extension-stroke liquid path 91). The seating surface 933 is arranged above the free end 931b of the leaf valve component 931 so as to be spaced apart from the leaf valve component 931. The seating surface 933 is flat and extends annularly so as to oppose to the free end 931b of the leaf valve component 931 over its entire circumference. The seating surface 933 is formed of a portion of a lower end surface of the lid member 953 on the radially inner side of the opposing surface 932.

The leaf valve component 931 is elastically deformed in the direction away from the seating surface 933 in the allowing stroke, during which the passage of the working fluid is allowed, so as to allow the passage of the working fluid through a clearance between the free end 931b and the opposing surface 932. For the extension-stroke valve 93, the allowing stroke corresponds to the extension stroke, and the restricting stroke, during which the passage of the working fluid is restricted, corresponds to the compression stroke. On the other hand, for the compression-stroke valve 94, the allowing stroke corresponds to the compression stroke, and the restricting stroke corresponds to the extension stroke.

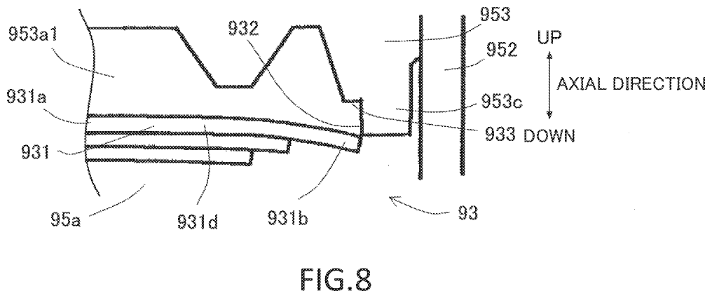

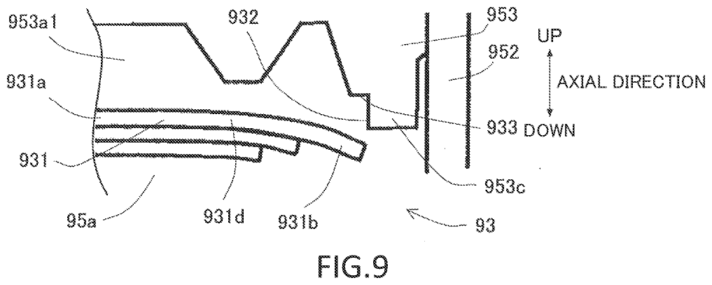

During the extension stroke in which the shock absorber 1 is extended (the stroke in which the piston 3 slides upwards), the liquid pressure in the liquid chamber 953a1 that is positioned above the leaf valve component 931 becomes higher than the liquid pressure in the liquid chamber 95a that is positioned below the leaf valve component 931. Due to this differential pressure, as shown in FIG. 8, the leaf valve component 931 is elastically deformed to cause the free end 931b to move downward, and as shown in FIG. 9, the clearance between the free end 931b of the leaf valve component 931 and the opposing surface 932 becomes large enough to allow the passage of the working fluid, thereby opening the extension-stroke valve 93.

As the extension-stroke valve 93 is opened, the working fluid flows into the lower chamber 22 from the upper chamber 21 via the extension-stroke liquid path 91. When the differential pressure is decreased due to the flow of the working fluid, the leaf valve component 931 is shifted, by its own restoring force, from a state shown in FIG. 9 to a state shown in FIG. 8, and then returns to a state shown in FIG. 7 (the initial state). In the state shown in FIG. 8, the passage of the working fluid is prohibited. At least in a state in which the outer circumferential surface of the leaf spring member 931d is positioned so as to oppose to the opposing surface 932, the passage of the working fluid is restricted or prohibited.

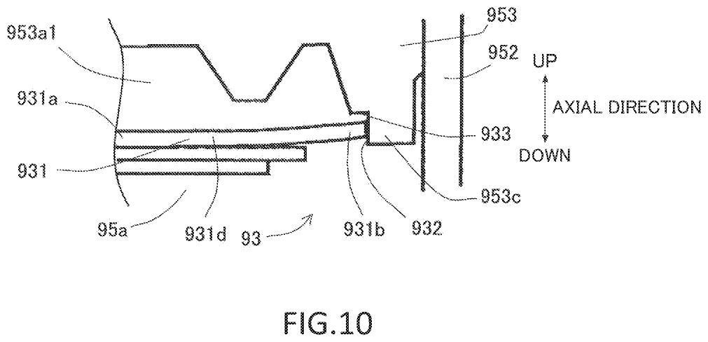

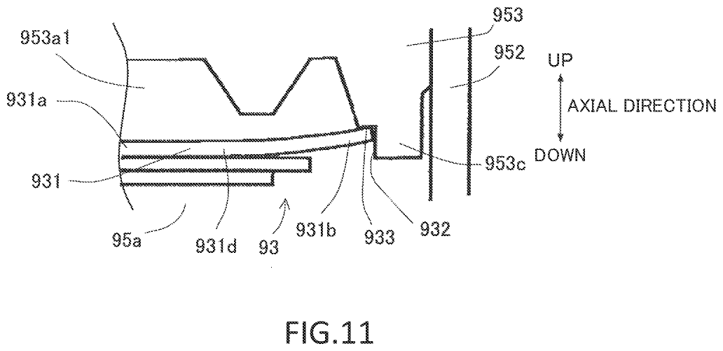

On the other hand, during the compression stroke in which the shock absorber 1 is compressed (the stroke in which the piston 3 slides downwards), the liquid pressure in the liquid chamber 95a that is positioned below the leaf valve component 931 becomes higher than the liquid pressure in the liquid chamber 953a1 that is positioned above the leaf valve component 931. Due to this differential pressure, the leaf valve component 931 is elastically deformed to cause the free end 931b to move upward and is shifted from the state shown in FIG. 7 to a state shown in FIG. 10, and as shown in FIG. 11, when the leaf valve component 931 is elastically deformed by a predetermined amount, the free end 931b is caused to be seated on (contact with) the seating surface 933.

In the state shown in FIG. 10, the clearance between the free end 931b and the opposing surface 932 is maintained small, and the passage of the working fluid through the clearance is completely or almost completely prevented. The extension-stroke valve 93 has a configuration in which slight (negligible) upward leakage of the working fluid is allowed in the state shown in FIG. 10. In a state shown in FIG. 11, the leaf valve component 931 is in contact with the seating surface 933, and the passage of the working fluid is prohibited (the passage is not allowed). As described above, the extension-stroke valve 93 restricts or prohibits the passage of the working fluid during the compression stroke and exhibits a function as a check valve.

In the state shown in FIG. 11, the leaf valve component 931 has been elastically deformed by a predetermined amount from the state shown in FIG. 7. This predetermined amount is set such that the leaf valve component 931 comes into contact with the seating surface 933 when the speed of the piston 3 exceeds an upper limit value of a predetermined normal range in the restricting stroke (in this case, the compression stroke). In other words, the leaf valve component 931 does not come into contact with the seating surface 933 when the speed of the piston 3 is equal to or lower than the upper limit value of the normal range during the restricting stroke. The speed of the piston 3 can also be referred to as stroke speed, and it can be measured by, for example, a rod-type displacement gauge or an acceleration sensor. It is also possible to predict the speed of the piston 3 by performing a simulation.

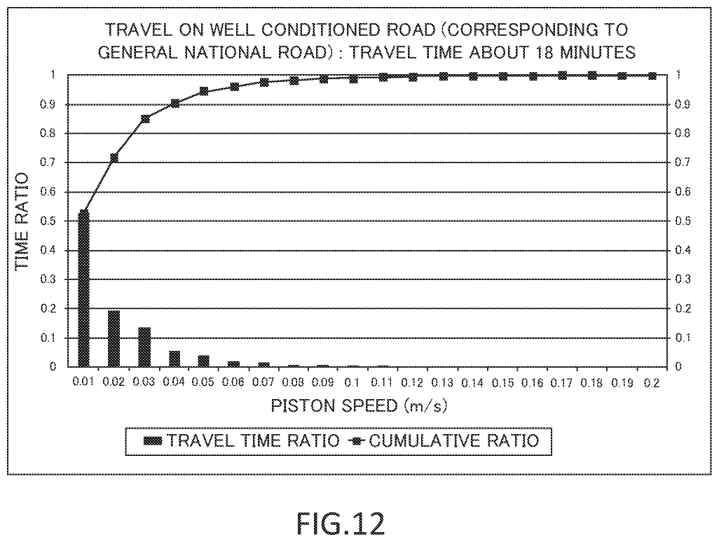

As shown in FIG. 12, from a relationship between the speed of the piston 3 and its frequency during travelling on a well conditioned road (corresponding to a general national road), it can be seen that the speed of the piston 3 is equal to or less than 0.1 m/s during most of the travel time. In addition, the speed of the piston 3 was equal to or less than 0.02 m/s for about 70% of the total travel time, and the speed of the piston 3 was equal to or less than 0.01 m/s for about 50% of the total travel time. It is possible to set the upper limit value of the normal range of the piston speed on the basis of the experimental values described above. For example, the range of the piston speed that accounts for 50% of the total travel time can be set as the normal range.

The upper limit value of the normal range is preferably a value from 0.01 m/s to 0.1 m/s, inclusive, for example. In such a case, in calculation, for about 50% or more of the total travel time, the leaf valve component 931 does not come into contact with the seating surface 933, while the contact (the seating) is achieved for the leaf valve component 931 and the seating surface 933 during the extension and compression with higher piston speed. Furthermore, the upper limit value of the normal range is preferably a value from 0.02 m/s to 0.1 m/s, inclusive. In such a case, in calculation, for 70% or more of the total travel time, the leaf valve component 931 does not come into contact with the seating surface 933. The lower the contact frequency between the leaf valve component 931 and the seating surface 933 is, the lower the generation frequency of the abnormal noise becomes.

The normal range of the piston speed may be set according to a vehicle type. In addition, the lower limit value of the normal range is zero. In addition, in FIG. 12, the horizontal axis represents the speed of the piston 3 (m/s), while the vertical axis represents a travel time ratio in the total travel time (bar graphs show the travel time ratio, and line graphs show the cumulative ratio). In the present experiment, a typical passenger car was used, and the total travel time was about 18 minutes.

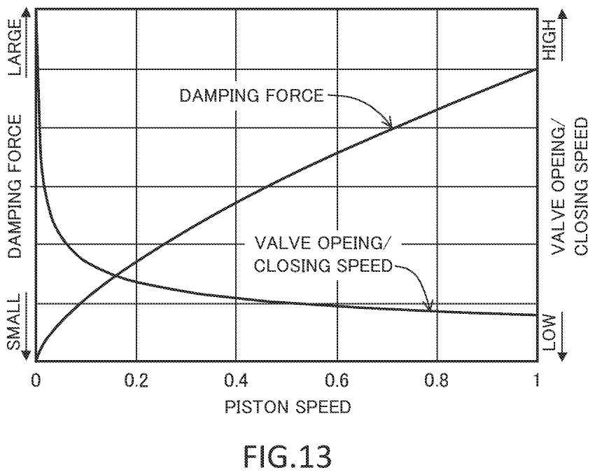

It is known that a damping force Fd of the extension-stroke valve 93 is proportional to the two-thirds power of the speed v of the piston 3 (Fd=K v^{2/3}) (K is a proportional constant). In addition, a lift amount (deformed amount) x of the leaf valve component 931 is proportional to the damping force Fd (x=k Fd) (k is a proportional constant). Therefore, as shown in FIG. 13, an opening/closing speed of the extension-stroke valve 93 is inversely proportional to the one-third power of the speed of the piston 3 (dx/dv=2/3k K v^{-1/3}). In other words, the higher the speed of the piston 3 is, the greater the damping force Fd becomes, and the lower the opening/closing speed of the extension-stroke valve 93 (a valve opening/closing speed) becomes. The lower the opening/closing speed of the extension-stroke valve 93 is, the smaller the sound caused when the leaf valve component 931 is seated on the seating surface 933 becomes.

For example, when the upper limit value of the normal range is set at 0.1 m/s, during the compression stroke, the leaf valve component 931 restricts the passage of the working fluid in the state shown in FIG. 10 if the speed of the piston 3 is equal to or less than 0.1 m/s. When a compression action is caused with the speed of the piston 3 exceeding 0.1 m/s, an elastically deformed amount (the lift amount) of the leaf valve component 931 is increased to start increasing the amount upward leakage of the working fluid; however, the leaf valve component 931 comes to be seated onto the seating surface 933 to prohibit the passage of the working fluid with reliability.

### (Detailed Configuration of Compression-Stroke Valve)

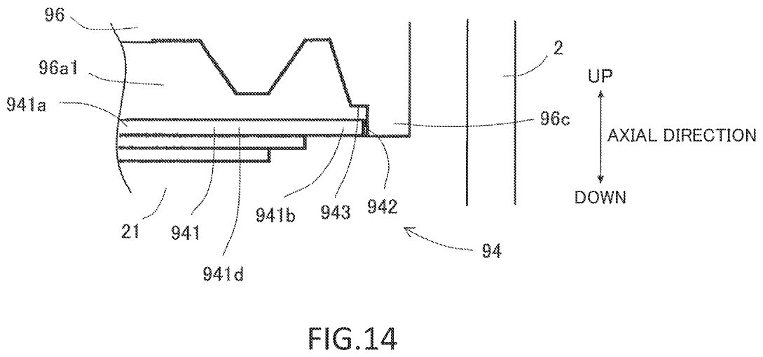

The compression-stroke valve 94 has the configuration similar to that of the extension-stroke valve 93, and as shown in FIGS. 2 and 14, the compression-stroke valve 94 has a configuration including a leaf valve component 941 (corresponding to “compression-stroke leaf valve component”), an opposing surface 942 (corresponding to “compression-stroke opposing surface”), and a seating surface 943 (corresponding to “compression-stroke seating surface”). An inner circumferential portion of the leaf valve component 941 is a fixed end 941a that is fixed to the hollow rod 4, and an outer circumference portion thereof is a free end 941b. The leaf valve component 941 is configured of one or more annular leaf spring member(s).

The leaf valve component 941 is arranged under the second liquid path forming portion 96 so as to close a lower end opening of the liquid path 96a (the liquid chamber 96a1). The leaf valve component 941 is formed by a plurality of annular leaf spring members stacked in the axial direction, and the damping characteristics can be adjusted by the number and the thickness of the leaf spring members. The leaf valve component 941 in the present embodiment is formed of three leaf spring members stacked in the axial direction with the outer diameter being reduced from the top towards the bottom. An outer circumference portion of the leaf valve component 941 is elastically deformed due to the differential pressure above and below it.

The opposing surface 942 opposes the free end 941b of the leaf valve component 941, and at least in a state in which the leaf valve component 941 is not elastically deformed, the opposing surface 942 prohibits, together with the leaf valve component 941, the passage of the working fluid in the liquid path where the leaf valve component 941 is arranged (in other words, the compression-stroke liquid path 92). A clearance between the leaf valve component 941 and the opposing surface 942 is set so as not to allow the passage of the working fluid. The opposing surface 942 is formed to have an annular shape so as to surround an outer circumferential surface of a leaf spring member 941d having the largest outer diameter of the leaf valve component 941. An overlapped amount in the radial direction between the leaf spring member 941d and the opposing surface 942 (corresponding to the thickness of the leaf spring member 941d) affects the ease of the state change from the closed state to the opened state of the compression-stroke valve 94. The position of a lower end of the leaf spring member 941d of the leaf valve component 941 coincides with the position of a lower end of the opposing surface 942 in the axial direction.

The opposing surface 942 is formed of a lower end portion of the second liquid path forming portion 96. An annular portion 96c which projects annularly is formed on an outer circumference portion of a lower end of the second liquid path forming portion 96. The opposing surface 942 is an inner circumferential surface of this annular portion 96c. An outer circumferential surface of the leaf valve component 941 opposes the inner circumferential surface of the annular portion 96c (the opposing surface 942) over its entire circumference.

In a case in which the leaf valve component 941 is elastically deformed by a predetermined amount in the restricting stroke, during which the passage of the working fluid is restricted, the seating surface 943 is brought into contact with the leaf valve component 941 and prohibits, together with the leaf valve component 941, the passage of the working fluid in the liquid path where the leaf valve component 941 is arranged (in other words, the compression-stroke liquid path 92). The seating surface 943 is arranged above the free end 941b of the leaf valve component 941 so as to be spaced apart from the leaf valve component 941. The seating surface 943 is flat and extends annularly so as to oppose to the free end 941b of the leaf valve component 941 over its entire circumference. The seating surface 943 is formed of a portion of a lower end surface of the second liquid path forming portion 96 on the radially inner side of the opposing surface 942.

The leaf valve component 941 is elastically deformed in the direction away from the seating surface 943 in the allowing stroke, during which the passage of the working fluid is allowed, so as to allow the passage of the working fluid through a clearance between the free end 941b and the opposing surface 942. For the compression-stroke valve 94, the allowing stroke corresponds to the compression stroke, and the restricting stroke corresponds to the extension stroke. The state change of the compression-stroke valve 94 is the same as the state change of the extension-stroke valve 93 as shown in FIGS. 7 to 11, and the illustration thereof will be omitted.

During the compression stroke in which the shock absorber 1 is compressed (the stroke in which the piston 3 slides downwards), the liquid pressure in the liquid chamber 96a1 that is positioned above the leaf valve component 941 becomes higher than the liquid pressure in the upper chamber 21 that is positioned below the leaf valve component 941. Due to this differential pressure, the leaf valve component 941 is elastically deformed to cause the free end 941b to move downward, and the clearance between the free end 941b of the leaf valve component 941 and the opposing surface 942 becomes large enough to allow the passage of the working fluid, thereby opening the compression-stroke valve 94. As the compression-stroke valve 94 is opened, the working fluid flows into the upper chamber 21 from the lower chamber 22 via the compression-stroke liquid path 92. When the differential pressure is decreased due to the flow of the working fluid, the leaf valve component 941 returns to the initial state by its own restoring force. At least in a state in which the outer circumferential surface of the leaf spring member 941d is positioned so as to oppose to the opposing surface 942, the passage of the working fluid is restricted or prohibited.

On the other hand, during the extension stroke in which the shock absorber 1 is extended (the stroke in which the piston 3 slides upwards), the liquid pressure in the upper chamber 21 that is positioned below the leaf valve component 941 becomes higher than the liquid pressure in the liquid chamber 96a1 that is positioned above the leaf valve component 941. Due to this differential pressure, the leaf valve component 941 is elastically deformed to cause the free end 941b move upward, and when the leaf valve component 941 is elastically deformed by a predetermined amount, the free end 931b is caused to be seated on (contact with) the seating surface 933.

In a state in which the free end 941b is moved upward (in a state in which the free end 941b is not seated), the clearance between the free end 941b and the opposing surface 942 is maintained small, and the passage of the working fluid through the clearance is completely or almost completely prevented. The compression-stroke valve 94 has a configuration in which slight (negligible) upward leakage of the working fluid is allowed. In a state in which the leaf valve component 941 is elastically deformed by a predetermined amount, the leaf valve component 941 is in contact with the seating surface 943 and the passage of the working fluid is prohibited (the passage is not allowed). As described above, the compression-stroke valve 94 restricts or prohibits the passage of the working fluid during the extension stroke and exhibits a function as a check valve.

As described above, the leaf valve component 941 is elastically deformed by a predetermined amount and seated onto the seating surface 943 from the initial state. This predetermined amount is set such that the leaf valve component 941 comes into contact with the seating surface 943 when the speed of the piston 3 exceeds the upper limit value of a predetermined normal range in the restricting stroke (in this case, the extension stroke). Similarly to the extension-stroke valve 93, the upper limit value of the normal range of the piston speed is set to a value from 0.01 m/s to 0.1 m/s, inclusive, or a value from 0.02 m/s to 0.1 m/s, inclusive, for example.

### (Effects Achieved by Extension-Stroke Valve and Compression-Stroke Valve)

According to the present embodiment, when the speed of the piston 3 is equal to or lower than the upper limit value of the normal range, the leaf valve component 931, 941 does not come into contact with the corresponding seating surface 933, 943 while restricting the passage of the working fluid. Therefore, the generation of the abnormal noise is suppressed. On the other hand, when the speed of the piston 3 exceeds the upper limit value of the normal range, the leaf valve component 931, 941 comes into contact with the corresponding seating surface 933, 943 to reliably prohibit the passage of the working fluid, and thereby, the leaf valve component 931, 941 functions as a check valve. Thus, in the restricting stroke, the sub-valve mechanism 9 functions as the highly accurate check valve by restricting the passage of the working fluid in the liquid paths 91 and 92 while suppressing the generation of the abnormal noise in the normal range of the speed of the piston 3, and by being seated at outside the normal range. In a region outside the normal range, in other words, in a region where the speed of the piston 3 is high, the damping force becomes large, and the elastic deformation speed of the leaf valve component becomes slow. Therefore, with this configuration, the level of the abnormal noise generated by seating is suppressed. As described above, according to the present embodiment, it is possible to realize the sub-valve mechanism 9 that can suppress the generation of the abnormal noise and exhibit the check valve function. Because at least one of the extension-stroke valve 93 and the compression-stroke valve 94 has the above-described configuration, it is possible to suppress the generation of the abnormal noise.

In addition, because the upper limit value of the normal range of the piston speed is set to a value from 0.01 m/s to 0.1 m/s, inclusive, or a value from 0.02 m/s to 0.1 m/s, inclusive, it is possible to suppress the generation of the abnormal noise for 50% or more of the total travel time. In the present embodiment, because the above-described configuration is employed in both of the extension-stroke valve 93 and the compression-stroke valve 94, the damping characteristics are almost the same in the extension stroke and the compression stroke. The liquid paths that allow the communication between the upper chamber 21 and the lower chamber 22 provided in the cylinder 2 include the communicating passages 31 and 32 and the liquid paths 91 and 92. In the present embodiment, the configuration corresponding to “the liquid path” in the present invention is the liquid path 91, 92, and the configuration corresponding to “the valve” in the present invention is the valve 93, 94. When “the liquid path” in the present invention corresponds to the communicating passage 31, 32, the configuration corresponding to “the valve” in the present invention is the main valve 81, 82.

### OTHERS

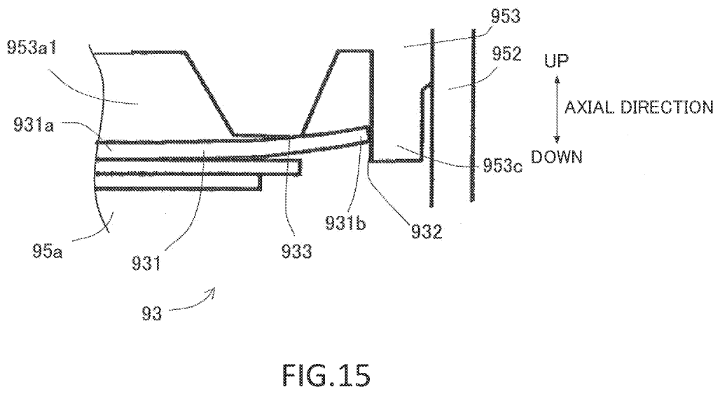

The present invention is not limited to the above-mentioned embodiment. For example, as shown in FIG. 15, the seating surface 933, 943 may be formed on the radially inner side than in the above-mentioned embodiment. Although the extension-stroke valve 93 is shown as a representative in FIG. 15, the same applies to the compression-stroke valve 94. Even with the configuration shown in FIG. 15, the leaf valve component 931, 941 comes into contact with the seating surface 933, 943 by being elastically deformed by a predetermined amount, which is set on the basis of the normal range of the piston speed. The configurations of the extension-stroke valve 93 and the compression-stroke valve 94 can be applied to any valve mechanisms requiring the check valve function.

In addition, the inner pipe 7 may be fixed to other portions than the lower end portion of the hollow rod 4. In addition, the inner pipe 7 may be arranged so as to cover a part of the inner circumferential surface of the rotary valve 5 corresponding to the inner liquid path 42, and for example, the lower end of the inner pipe 7 may be positioned above the lower end of the rotary valve 5. In this case, the inner liquid path 42 is partitioned by, for example, the inner circumferential surface of the inner pipe 7, the inner circumferential surface of the rotary valve 5, and the inner circumferential surface of the hollow rod 4. Because the inner pipe 7 covers at least a part of the inner circumferential surface of the rotary valve 5 corresponding the inner liquid path 42, the torque received by the rotary valve 5 due to the fluid force from the working fluid is reduced. The configuration including the inner pipe 7 can be applied to any valve mechanisms including the rotary valve 5.

In addition, the present invention may be applied to the main valve mechanism 8. In other words, similarly to the present embodiment, at least one of the first main valve 81 and the second main valve 82 may be configured to include the leaf valve component, the opposing surface, and the seating surface. Also with such a configuration, similarly to the present embodiment, it is possible to realize the valve mechanism that can suppress the generation of the abnormal noise and exhibit the check valve function. As described above, according to the present invention, it is possible to form the leaf valve component, the opposing surface, and the seating surface for at least one of the first main valve 81, the second main valve 82, the extension-stroke valve 93, and the compression-stroke valve 94. As described above, the valve configuration of the present invention (the leaf valve component, the opposing surface, and the seating surface) can be applied to any valves of the shock absorber, for example, the main valve, the sub-valve, a valve of a base valve (for example, a valve provided in the base valve that is provided on one end portion of an inner tube in a twin-tube shock absorber having the inner tube and an outer tube), a valve of an external damping part (for example, a valve provided in the damping part that is provided in an outer circumference of a tubular main body portion in a triple-tube type shock absorber), and so forth. Also in these cases, because the valve is provided for the liquid path that allows communication between chambers provided in the shock absorber, it is possible to apply the leaf valve component, the opposing surface, and the seating surface for such a valve.

The embodiment of the present invention is described as above, but the above-described embodiment illustrates only a part of an application example of the present invention and is not intended to limit the technical scope of the present invention to the specific configuration of the above-described embodiment.

The present application claims for priority based on Japanese Patent Application No. 2021-163507 filed with Japan Patent Office on Oct. 4, 2021, and all the contents of this application are incorporated in this description by reference.

1. A shock absorber comprising:
a cylinder;
a piston slidably arranged in the cylinder, the piston being configured to partition an interior of the cylinder into a first chamber and a second chamber;
a liquid path configured to allow communication between the first chamber and the second chamber provided in the cylinder; and
a valve provided for the liquid path, wherein
the valve comprises:
a leaf valve component having a fixed end and a free end;
an opposing surface opposing to the free end of the leaf valve component, the opposing surface being configured to prohibit, at least in a state in which the leaf valve component is not elastically deformed, together with the leaf valve component, passage of working fluid in the liquid path where the leaf valve component is arranged; and
a seating surface configured to prohibit, in a case in which the leaf valve component is elastically deformed by a predetermined amount in a restricting stroke, during which passage of the working fluid is restricted, together with the leaf valve component by coming into contact with the leaf valve component, passage of the working fluid in the liquid path where the leaf valve component is arranged, and wherein
in an allowing stroke, during which passage of the working fluid is allowed, the leaf valve component is elastically deformed in a direction away from the seating surface so as to allow passage of the working fluid via a clearance between the free end and the opposing surface, and
the predetermined amount is set such that the leaf valve component comes into contact with the seating surface when a speed of the piston exceeds an upper limit value of a predetermined normal range in the restricting stroke.

2. The shock absorber according to claim 1, further comprising:
a communicating passage provided in the piston and configured to allow communication between the first chamber and the second chamber;
a valve mechanism provided for the communicating passage;
an extension-stroke liquid path and a compression-stroke liquid path, at least one of which forms the liquid path, the extension-stroke liquid path and the compression-stroke liquid path being provided separately from the communicating passage, and the extension-stroke liquid path and the compression-stroke liquid path being configured to independently allow communication between the first chamber and the second chamber;
an extension-stroke valve configured to allow passage of the working fluid from the first chamber to the second chamber via the extension-stroke liquid path in an extension stroke and to restrict passage of the working fluid from the second chamber to the first chamber via the extension-stroke liquid path in a compression stroke; and
a compression-stroke valve configured to allow passage of the working fluid from the second chamber to the first chamber via the compression-stroke liquid path in the compression stroke and to restrict passage of the working fluid from the first chamber to the second chamber via the compression-stroke liquid path in the extension stroke, wherein
at least one of the extension-stroke valve and the compression-stroke valve corresponding to the liquid path forms the valve and includes the leaf valve component, the opposing surface, and the seating surface.

3. The shock absorber according to claim 2, wherein
the extension-stroke valve comprises:
an extension-stroke leaf valve component serving as the leaf valve component;
an extension-stroke opposing surface serving as the opposing surface opposing to the free end of the extension-stroke leaf valve component, the extension-stroke opposing surface being configured to prohibit, at least in a state in which the extension-stroke leaf valve component is not elastically deformed, together with the extension-stroke leaf valve component, passage of the working fluid in the extension-stroke liquid path; and
an extension-stroke seating surface serving as the seating surface configured to prohibit, in a case in which the extension-stroke leaf valve component is elastically deformed by the predetermined amount in the compression stroke, together with the extension-stroke leaf valve component by coming into contact with the extension-stroke leaf valve component, passage of the working fluid in the extension-stroke liquid path, wherein
in the extension stroke, the extension-stroke leaf valve component is elastically deformed in a direction away from the extension-stroke seating surface so as to allow passage of the working fluid via a clearance between the free end and the extension-stroke opposing surface, and
the compression-stroke valve comprises:
a compression-stroke leaf valve component serving as the leaf valve component;
a compression-stroke opposing surface serving as the opposing surface opposing to the free end of the compression-stroke leaf valve component, the compression-stroke opposing surface being configured to prohibit, at least in a state in which the compression-stroke leaf valve component is not elastically deformed, together with the compression-stroke leaf valve component, passage of the working fluid in the compression-stroke liquid path; and
a compression-stroke seating surface serving as the seating surface configured to prohibit, in a case in which the compression-stroke leaf valve component is elastically deformed by the predetermined amount in the extension stroke, together with the compression-stroke leaf valve component by coming into contact with the compression-stroke leaf valve component, passage of the working fluid in the compression-stroke liquid path, wherein
in the compression stroke, the compression-stroke leaf valve component is elastically deformed in a direction away from the compression-stroke seating surface so as to allow passage of the working fluid via a clearance between the free end and the compression-stroke opposing surface.

4. The shock absorber according to claim 1, wherein
the liquid path is at least one of a first communicating passage and a second communicating passage configured to allow communication between the first chamber and the second chamber provided in the piston, the first communicating passage and the second communicating passage being provided independently from each other, and
the valve provided for the liquid path comprises the leaf valve component, the opposing surface, and the seating surface.

5. The shock absorber according to claim 1, wherein
an upper limit value of the normal range is set to a value from 0.01 m/s to 0.1 m/s, inclusive.

6. The shock absorber according to claim 1, wherein
an upper limit value of the normal range is set to a value from 0.02 m/s to 0.1 m/s, inclusive.

7. A valve provided in a shock absorber, wherein
the valve is provided for a liquid path configured to allow communication between chambers provided in the shock absorber, and
the valve comprises:
a leaf valve component having a fixed end and a free end;
an opposing surface opposing to the free end of the leaf valve component, the opposing surface being configured to prohibit, at least in a state in which the leaf valve component is not elastically deformed, together with the leaf valve component, passage of working fluid in the liquid path where the leaf valve component is arranged; and
a seating surface configured to prohibit, in a case in which the leaf valve component is elastically deformed by a predetermined amount in a restricting stroke, during which passage of the working fluid is restricted, together with the leaf valve component by coming into contact with the leaf valve component, passage of the working fluid in the liquid path where the leaf valve component is arranged.
